(19) United States
(12) Patent Application Publication
(10) Pub. No.: US 2026/0243736 A1
(43) Pub. Date: Aug. 20, 2026

(54) GDV OPTIMIZED INJECTION WITH SAMPLE PRE-COMPRESSION

(71) Applicant: Dionex Softron GmbH, Germering (DE)

(72) Inventor: Thomas Wachinger, Altomünster (DE)

(21) Appl. No.: 19/054,382

(22) Filed: Feb. 14, 2025

(51) Int. Cl. G01N 30/20; B01D 15/10; B01D 15/14; G01N 30/32; G01N 30/88

(52) U.S. Cl. CPC G01N 30/20; B01D 15/102; B01D 15/14; G01N 30/32; G01N 30/88; G01N 2030/207; G01N 2030/324; G01N 2030/326; G01N 2030/889

(57) ABSTRACT

The present invention relates to a method for operating a chromatography system, wherein the chromatography system comprises a pump, a metering device, a sample loop, a separation column, and an injection valve, the method comprising injecting a sample stored in the sample loop into the separation column, without the metering device being part of an analytical path, and injecting a sample stored in the sample loop into the separation column with the metering device being part of the analytical path, wherein the analytical path denotes a flow path between the pump and the separation column. Further, the present invention relates to a respective system and computer program product.

The present invention generally relates to a chromatography system comprising a switching valve or injection valve, preferably liquid chromatography (LC) system and a corresponding method. More specifically, the present invention may relate to a chromatography system comprising an injection valve allowing for GDV optimized injection with sample precompression.

Injection valves may be used in autosamplers to inject a sample to be analysed in a solvent stream. For this purpose, the sample may first be drawn into a sample loop at atmospheric pressure and then be pre-compressed to system pressure. During injection, the sample is then be transported by the solvent pump towards the analytical column, which separates the sample components over time. The analytes may then be determined in a downstream detector. The injection valve may typically be designed as a shear valve with ports and grooves and configured such that different components can be fluidically connected or separated.

In the following the present invention is generally discussed with reference to high-performance liquid chromatography (HPLC). However, it will be understood that the present invention may also relate to other LC methods and systems, e.g. LC or ultra high performance liquid chromatography (UHPLC).

For example, DE 10 2016 101 658 B 4 and U.S. Pat. No. 11,867,669 B2 disclose use of a single injection valve for sample injection, while U.S. Pat. No. 10,816,515 B2 and JP 4955342 B2 disclose injection systems comprising two valves. All the afore mentioned documents disclose systems wherein the sample is drawn into a sample loop via a needle using a so-called metering device, wherein the sample loop can be split between the needle and a needle seat (split loop). The sample loop can be connected directly to the metering device or indirectly via additional ports of the valve(s). When the sample is injected, i.e. when the sample loop is switched into the analytical path (solvent pump to column connection), the metering device also becomes part of the analytical path in various embodiments. However, there are also embodiments in which the metering device does not become part of the analytical path.

On the one hand, it can be disadvantageous if the metering device is switched into the analytical path during injection, as the metering device causes additional gradient delay volume (GDV). For analyses with low flows, the GDV causes a long analysis time as the gradient has to be pumped through the entire volume.

On the other hand, it can also be disadvantageous if the metering device does not remain part of the analytical path after injection, as the new GDV shifts the retention times when emulating existing chromatographic method on new HPLC systems. New HPLC systems often have less GDV. To emulate an older HPLC system with more GDV, the metering device can be used as an aid. For this, the additional desired GDV may be set by the piston position as for example disclosed in DE 10 2014 103 766B4 . A further disadvantage is that the metering device is no longer flushed through by the solvent flow and therefore a washing process for the metering device is necessary, for example, to prevent carry over or to transfer the starting gradient/starting solvent into the metering device.

In light of the above, it is an object to overcome or at least alleviate the shortcomings and disadvantages of the prior art. More particularly, it is an object of the present invention to provide for a system and/or method wherein the metering device can selectively be switched in and out of the analytical path.

These objects are met by the present invention.

In a first embodiment, the present invention relates to a method for operating a chromatography system, wherein the chromatography system comprises a pump, a metering device, a sample loop, a separation column, and an injection valve, the method comprising injecting a sample stored in the sample loop into the separation column, without the metering device being part of an analytical path; and injecting a sample stored in the sample loop into the separation column with the metering device being part of the analytical path, wherein the analytical path denotes a flow path between the pump and the separation column.

The analytical path may particularly denote the flow path between an outlet of the pump and an inlet of the separation column.

In other words, a method for operating a chromatography system is provided, wherein the method comprises two different injection procedures. This advantageously allows for a greater flexibility when operating the chromatography system, since the metering device can selectively be switched out of the analytical flow path during sample injection. Thus, the method allows for injecting a sample with an adjusted GDV (when the metering device is comprised by the analytical flow path) as well as injecting a sample with an optimized GDV (when the metering device is not comprised by the analytical path), i.e. a lower GDV compared to having the metering device in the analytical path.

The step of injecting a sample without the metering device being part of the analytical path may comprise the system assuming a first injection configuration, wherein the analytical path comprises the sample loop, the sample pickup means, and the seat, but not the metering device.

The step of injecting a sample without the metering device being part of the analytical path may further comprise decompressing the metering device to ambient pressure; and subsequently pressurizing the metering device to system pressure. In particular, the metering device may advantageously be decompressed to ambient pressure at the beginning of injecting the sample and may subsequently be pressurized prior to switching it back into a system flow path at operating pressure (also referred to as system pressure), e.g. once the injection if finished. This may advantageously allow to keep the metering device at ambient pressure during sample analysis and at the same time avoid pressure fluctuations when switching the valve position, e.g. after analysis. It will be understood that system pressure relates to the pressure present at the separation column, particularly at the inlet of the separation column.

The step of injecting a sample with the metering device being part of the analytical path may comprise the system assuming a second injection configuration, wherein the analytical path comprises the metering device, the sample loop, the sample pickup means and the seat. In other words, a method for operating a chromatography system is provided, wherein the method comprises the system assuming two injection configurations that differ in which components are comprised by the analytical path between the pump and the separation column.

The step of injecting a sample with the metering device being part of the analytical path may comprise adjusting the gradient delay volume in the analytical path by means of the metering device. That is, the GDV may for example be increased by means of the metering device. This may be advantageous for emulating analysis procedures which have been carried out on different (oftentimes older) systems with a comparatively higher GDV.

The hardware of the system including comprised parts, components and the respective tubing are not manually changed during the method. That is, it may advantageously be possible to switch between the two types of injection (two injection configurations) without any manual changes to the system. Thus, a change between injection with and without metering device in the analytical flow path may for example be performed purely by via a controller/software. This advantageously provides great flexibility and reduces sources of error, which may occur when performing hardware modifications.

The method may further comprise equilibrating the separation column with solvent provided by the pump. Equilibrating the separation column may comprise the system assuming an equilibration configuration wherein the analytical path does not comprise the metering device, the sample loop, the sample pickup means or the seat.

The method may further comprise picking up a sample and storing it in the sample loop. The step of picking up the sample and storing it may comprise the system assuming a sample-pickup configuration, wherein the metering device is fluidly connected to a dead end, and to the sample loop and the sample pickup means, and wherein the sample pickup means is separated from the seat and moved to a sample vial. In particular, the step of picking up the sample and storing it may comprise separating the sample pickup means from the seat and moving it to a sample vial.

The step of picking up the sample and storing it may comprise drawing in at least a portion of sample from a sample vial into the sample loop by means of the metering device.

In some embodiments, the step of picking up the sample and storing it may comprise repeatedly drawing in a portion of sample from a sample vial into the sample loop, with interrupted draining of solvent from the metering device. Thus, the present method may allow for multi-draw procedures, wherein for example a larger amount of sample may be drawn into the sample loop through repeatedly picking portions of sample.

The step of picking up the sample and storing it may comprise drawing in a first portion of sample from a sample vial into the sample loop by means of the metering device, draining of solvent from the metering device to a waste, and drawing in a second portion of sample from a sample vial into the sample loop by means of the metering device.

The step of picking up the sample and storing it may comprise the system assuming a sample-pickup configuration, drawing in a first portion of sample from a sample vial into the sample loop by means of the metering device, the system assuming a configuration wherein the metering device is fluidly connected to waste and to a dead end, draining of solvent from the metering device to a waste, and the system assuming the sample-pickup configuration, drawing in a second portion of sample from a sample vial into the sample loop by means of the metering device.

The method may comprise providing an uninterrupted solvent flow to the separation column during the step of picking up the sample and storing it. This may advantageously allow to keep the separation column equilibrated and thus ready for sample injection.

The step of picking up a sample and storing it may additionally or alternatively comprise drawing in at least a portion of sample from a sample vial into the sample loop by means of the metering device, draining solvent from the metering device to a waste, and drawing in at least a portion of a fluid other than sample from a vial into the sample loop by means of the metering device. This may for example allow to dilute a sample. It will be understood that also multiple portions of sample and fluid other than sample may be drawn into the sample loop, e.g. in an alternating manner. Such a fluid other than sample may particularly be a solvent.

The method may further comprise pre-compressing a sample stored in the sample loop. The step of pre-compressing the sample may comprise pressurizing the sample to system pressure by means of the metering device. The step of pre-compressing the sample may comprise the system assuming a sample-precompression configuration, wherein the metering device is fluidly connected to the sample loop and the sample pickup means, which is received by the seat, and both the seat and the metering device are each fluidly connected to a dead end, such that the metering device can pressurize the sample loop.

The method may further comprise washing, refilling and/or equilibrating metering device, seat, sample pickup means, sample loop, injection valve and/or separation column. The step of washing, refilling and/or equilibrating may comprise assuming a second injection configuration wherein the analytical path comprises the metering device, the sample loop, the sample pickup means and the seat. such that metering device, seat, sample pickup means sample loop, at least the ports and connecting elements of the injection valve which are part of the analytical flow path when assuming the second injection configuration, and the separation column are fluidly connected to the pump and can be provided with solvent. In particular, even when injecting a sample without the metering device being in the analytical flow path, the system may subsequently assume a configuration wherein also the metering device is comprised in the analytical flow path, e.g. for washing thereof. In particular, even when injecting a sample assuming the first injection configuration, the system may assume the second injection configuration for washing, refilling and/or equilibrating parts of the system.

The method may further comprise decompressing the sample loop, the seat, the sample pickup means and the metering device after sample injection and/or the step of washing, refilling and/or equilibrating. The step of decompressing may comprise assuming a sample-precompression configuration.

The method may further comprise detecting sample constituents in an effluent of the separation column.

The method may comprise purging the pump. The step of purging the pump may comprise the system assuming a pump-purge configuration wherein the pump is fluidly connected to waste.

The method may comprise washing the metering device. The step of washing the metering device may comprise providing a solvent flow through the metering device, which is preferably subsequently guided to waste. Additionally or alternatively, the step of washing the metering device may comprise the system assuming a metering-device wash configuration, wherein the metering device is fluidly connected to the pump and to waste.

The method may comprise performing system diagnostics to detect leaks within the system. System diagnostics may for example be performed prior to analysing a sample in order to ensure correct functionality of the system.

Performing system diagnostics may comprise performing a leak test for the sample pickup means, the seat and the sample loop. Performing the leak test for the sample pickup means, the seat and the sample loop may comprise pressurizing the sample loop, the sample pickup means and the seat by means of the pump. Additionally or alternatively, performing the leak test for the sample pick up means, the seat and the sample loop may comprise the system assuming a first leak-test configuration, wherein the pump is fluidly connected to a dead end said fluid connection comprises the sample pickup means, the seat and the sample loop but not the metering device or the separation column.

Performing system diagnostics may comprise performing a leak test for the metering device. Performing the leak test for the metering device may comprise pressurizing the metering device by means of the pump. Additionally or alternatively, performing the leak test for the metering device may comprise the system assuming a second leak-test configuration, wherein the pump is fluidly connected to a dead end and said fluid connection comprises the metering device but not the sample loop, the sample pickup means, the seat or the separation column.

Performing system diagnostics may comprise performing a leak test for the pump. Performing the leak test for the pump may comprise pressurizing the pump, particularly at the pump outlet. Additionally or alternatively, performing the leak test for the pump may comprise the system assuming a third leak-test configuration, wherein the pump is fluidly connected to a dead end, without the metering device, the sample loop, the sample pickup means, the seat or the separation column being part of said fluid connection.

Performing system diagnostics may comprise performing a leak test for an injection path comprising the metering device, the sample loop, the sample pickup means and the seat. Performing a leak test for the injection path may comprise pressurizing the injection path with the pump. Additionally or alternatively, performing the leak test for the injection path may comprise the system assuming a fourth leak-test configuration, wherein the pump is fluidly connected to a dead end and wherein said fluid connection comprises the seat, the sample pickup means, the sample loop and the metering device, but not the separation column.

Generally, performing a respective leak test may comprise pressurizing a flow path to a desired operating pressure, and monitoring a decay of the once established pressure over a period of time to quantify an amount of leakage. Alternatively, performing a respective leak test may comprise pressurizing a flow path to a desired operating pressure, Maintaining the operating pressure over a period of time, and monitoring a required piston movement of the pump to quantify an amount of leakage. It will be understood that the method may generally comprise performing a leak test based on monitoring a pressure decay and performing a leak test based on monitoring the piston movement.

The method may comprise maintaining a fluidic connection of the pump to the separation column while switching from the system assuming the equilibration may comprise to the system assuming the sample-pickup configuration. Similarly, the method comprises maintaining a fluidic connection of the pump to the separation column while switching from the system assuming the sample-pickup configuration to the system assuming the sample-precompression configuration. Maintaining the fluidic connection of the pump to the separation column advantageously allows to keep the separation column equilibrated and thus ready for sample injection.

In another aspect, the present invention relates to a chromatography system comprising an injection valve comprising at least 6 ports, a pump, a separation column, a metering device, a sample loop, a sample pickup means, and a seat configured to receive and fluidly connect to the sample pick up means; wherein the system is configured to assume a first injection configuration, wherein an outlet of the pump is fluidly connected to an inlet of the separation column and wherein a resulting flow path between the pump and the separation column comprises the sample loop, the sample pickup means, and the seat, but not the metering device; and wherein the system is configured to assume a second injection configuration, wherein the outlet of the pump is fluidly connected to the inlet of the separation column and wherein a resulting flow path between the pump and the separation column comprises the metering device the sample loop, the sample pickup means and the seat.

The chromatography system may simply also be referred to as the system. Thus, a chromatography system is provided, which is configured to assume two different injection configurations that differ particularly in whether the metering device is part of the analytical flow path or not. As outlined above, this may advantageously allow for greater flexibility for operating with different injection procedures.

The outlet of the pump may be directly fluidly connected to a first port of the injection valve. It will be understood that a component being directly fluidly connected to another component is defined as no other port or connecting element of the injection valve being part of said fluidic connection.

An inlet of the pump may be fluidly connected to at least one solvent reservoir. That is, the pump may generally be configured to provide a solvent or solvent mixture, wherein the solvent(s) is/are provided in respective reservoir(s) fluidly connected to an inlet of the pump.

The pump may be configured to provide fluid at pressures of at least up to 200 bar, preferably at least up to 500 bar, more preferably at least up to 1000 bar, even more preferably at least up to 1500 bar. Thus, the pump may generally be configured for typical pressures in HPLC and UHPLC applications.

The inlet of the separation column may be directly fluidly connected to a second port of the injection valve.

The system may further comprise a detector and wherein an outlet of the separation column is fluidly connected to an inlet of the detector.

In some embodiments, a device inlet of the metering device may be directly fluidly connected to a fourth port of the injection valve and a device outlet of the metering device may be directly fluidly connected to a fifth port of the injection valve. It will be understood that the terms “device inlet” and “device outlet” do not restrict the metering device 40 to a single direction of flow, but rather serve to distinguish the two connections of the metering device. That is, the “device inlet” and the “device outlet” may both serve to receive and to provide fluid.

The metering device may comprise a housing and a piston, wherein the piston can be moved within the housing to provide a negative or positive pressure for moving fluids. The metering device may be a syringe. The metering device may comprise a drive for moving the piston. For example, the metering device may comprise a stepper motor or other drive device for moving the piston.

A first loop end of the sample loop may be directly fluidly connected to a third port of the injection valve, a second loop end of the sample loop may be directly fluidly connected to the sample pick up means, and the seat may be directly fluidly connected to a sixth port of the injection valve.

The sample pickup means may be a needle and the seat is a needle seat.

The injection valve may be a shear valve. The injection valve may comprise a rotor and a stator. Preferably, all ports of the injection valve may be comprised by the stator.

The injection valve may comprise at least four connecting elements. Generally, the connecting elements may be grooves in the stator or rotor. Preferably all connecting elements, e.g. grooves, may be comprised by the rotor.

The injection valve may comprise at most seven ports.

The system may further comprise a waste. The waste may generally be configured to dispose of liquids. The waste may be directly fluidly connected to a seventh port of the injection valve.

In some embodiments, the injection valve may comprise exactly six ports.

The system may comprise only a single injection valve directly involved in the sample injection. That is a single injection valve that enables establishing of the fluidic connections required for injecting the sample. That is, switching from a picking up a sample and/or recompressing a sample to either one of the injection positions merely requires changing the valve position of the single injection valve.

The system may comprise a controller configured to control the system during operation. The controller may be operatively connected to the injection valve, the sample pickup means, the pump and the metering device.

In the first injection configuration the resulting flow path between the pump and the separation column may not comprise dead volume within the injection valve. In particular, in the first injection configuration there may be no dead volume in the connecting elements of the injection valve comprised by the resulting flow path between the pump and the separation column.

In the first injection configuration the first port may be fluidly connected to the third port and the second port may be fluidly connected to the sixth port or vice-versa, wherein the connection is solely established within the injection valve.

In the second injection configuration the resulting flow path between the pump and the separation column may not comprise dead volume within the injection valve downstream of the sample loop. In particular, in the second injection configuration there may be no dead volume in the connecting element(s) of the injection valve comprised by the resulting flow path between the pump and the separation column downstream of the sample loop.

In the second injection configuration the metering device may be located upstream of the sample loop.

In the second injection configuration one of the fourth port and the fifth port may be fluidly connected to the first port, while the remaining of the two may be fluidly connected to the sixth port or the third port, and the second port may be connected to the other one of the sixth port and the third port, wherein the respective connections are solely established within the injection valve.

The system may further be configured to assume an equilibration configuration designed for equilibration of the separation column. In the equilibration configuration the outlet of the pump may be fluidly connected to the inlet of the separation column without the metering device, the sample loop, the sample pickup means or the seat being part of the respective connection.

In the equilibration configuration the outlet of the pump may be fluidly connected to the inlet of the separation column via a single connecting element.

In the equilibration configuration the first port may be fluidly connected to the second port solely within the injection valve.
in the equilibration configuration a flow path between the pump and the separation column may not comprise dead volume within the injection valve. In particular, in the equilibration configuration there may be no dead volume in the connecting element of the injection valve comprised by a flow path between the pump and the separation column.

The system may further be configured to assume a sample-pickup configuration designed for picking up a sample with the sample pickup means and storing it in the sample loop. In the sample-pickup configuration the metering device may be fluidly connected to the sample loop and the sample pickup means, and wherein the sample pickup means may be separated from the seat and moved to a sample vial.

In the sample-pickup configuration the pump may still fluidly connected to the separation column.

In the sample-pickup configuration the first port may be fluidly connected to the second port solely within the injection valve.

In the sample-pickup configuration one of a device inlet of the metring device and a device outlet of the metering device may be fluidly connected to a dead end such that the metering device can provide a negative pressure for drawing in a sample from the sample vial.

In the sample-pickup configuration the fourth or the fifth port may be fluidly connected to the sixth port solely within the injection valve and wherein the other one of the two may be blocked or connected to a dead end.

The system may further be configured to assume a sample-precompression configuration designed to pressurize a sample in the sample loop to system pressure. In the sample-precompression configuration the metering device may be fluidly connected to the sample loop, the sample pickup means may be received by the seat and both the seat and the metering device may each be fluidly connected to a dead end, such that the metering device can pressurize the sample loop.

In the sample-precompression configuration the pump may still be fluidly connected to the separation column.

In the sample-precompression configuration the first port may be fluidly connected to the second port solely within the injection valve.

In the sample-precompression configuration the fourth or the fifth port may be fluidly connected to the sixth port solely within the injection valve and wherein the other one of the two may be blocked or connected to a dead end, and the sixth port may be blocked or connected to a dead end.

The system may further be configured to assume a pump-purge configuration designed for purging the pump. In the pump-purge configuration the pump may be fluidly connected to waste.

In the pump-purge configuration the first port may be fluidly connected to the seventh port solely within the injection valve.

The system may further be configured to assume a metering-device wash configuration designed for washing the metering device. In the metering-device wash configuration the metering device may be fluidly connected to the pump and to waste.

In the metering-device wash configuration one of the fourth port and the fifth port may be fluidly connected to the first port solely within the injection valve and the other one of the fourth port and the fifth port may be fluidly connected to the seventh port solely within the injection valve.

The system may further be configured to assume a first leak-test configuration designed to pressurize the sample pickup means, the seat and the sample loop by means of the pump. In the first leak-test configuration the pump may be fluidly connected to a dead end, wherein the respective fluid connection comprises the sample loop, the sample pickup means and the seat but not the metering device.

In the first leak-test configuration the first port may be fluidly connected to one of the third port and the sixth port solely within the injection valve and wherein the other one of the third port and the sixth port may be blocked or fluidly connected to a dead end solely within the injection valve.

The system may further be configured to assume a second leak-test configuration designed to pressurize the metering device. In the second leak-test configuration the pump may be fluidly connected to a dead end, wherein the respective fluid connection comprises the metering device but not the sample loop, the sample pickup means, the seat or the separation column.

In the second leak-test configuration the first port may be fluidly connected to one of the fourth port and the fifth port solely within the injection valve and wherein the other one of the fourth port and the fifth port may be blocked or fluidly connected to a dead end solely within the injection valve.

The system may further be configured to assume a third leak-test configuration designed to pressurize the pump, particularly at the pump outlet. In the third leak-test configuration the pump may be fluidly connected to a dead end, without the metering device, the sample loop, the sample pickup means, the seat or the separation column being part of the respective fluid connection.

In the third leak-test configuration the first port may be blocked or fluidly connected to a dead end solely within the injection valve.

The system may further be configured to assume a fourth leak-test configuration designed to pressurize the seat, the sample pickup means, the sample loop, and the metering device. In the fourth leak-test configuration the pump may be fluidly connected to a dead end, wherein the respective fluid connection comprises the seat, the sample pickup means, the sample loop and the metering device, but not the separation column.

In the fourth leak-test configuration the first port may be fluidly connected to one of the third port and the sixth port solely within the injection valve, the other one of the third port and the sixth port may be fluidly connected to the fourth port or the fifth port solely within the injection valve, and the other one of the fourth port and the fifth port may be blocked or fluidly connected to a dead end solely within the injection valve.

The chromatography system may be a liquid chromatography system. In particular, the chromatography system may be a high-performance liquid chromatography system.

The system may be configured to operate at fluid pressures of at least up to 200 bar, preferably at least up to 500 bar, more preferably at least up to 1000 bar, even more preferably at least up to 1500 bar.

The controller may be configured to perform the herein described method.

The system may be configured to switch between assuming the equilibration configuration and assuming the sample-pickup configuration without disconnecting the pump from the separation column. Additionally or alternatively, the system may be configured to switch between assuming the sample-pickup configuration and assuming the sample-precompression configuration without disconnecting the pump from the separation column.

For the method described above, the chromatography system may be a chromatography system as described herein.

The configurations assumed by the system during the herein disclosed method may be the configurations as defined for herein described system.

In a further embodiment, the present invention relates to a computer program product comprising instructions which, when the program is executed by a chromatography system as described herein, cause the chromatography system to carry out the herein described method.

Similarly, the present invention may relate to a computer program product comprising instructions which, when the program is executed by the controller of a chromatography system as described herein, cause the controller to operate the chromatography system according to the herein described method.

That is, the present invention provides a system, method and related computer program product, which allow for realizing two different injection configurations within a single chromatography system without requirement of any hardware changes to switch between injection configurations.

For example, the metering device can be switched into the analytical path to be able to carry out GDV changes, washing or filling processes with or for the metering device. In addition, the metering device can also be switched out of the analytical path during sample injection or not have to switch it in at all to be able to provide the lowest possible GDV.

Below, reference will be made to method embodiments. These embodiments are abbreviated by the letter “M” followed by a number. Whenever reference is herein made to “method embodiments”, these embodiments are meant.

M1. Method for operating a chromatography system, wherein the chromatography system comprises a pump, a metering device, a sample loop, a separation column, and an injection valve, the method comprising injecting a sample stored in the sample loop into the separation column, without the metering device being part of an analytical path; and injecting a sample stored in the sample loop into the separation column with the metering device being part of the analytical path; wherein the analytical path denotes a flow path between the pump and the separation column.

The analytical path may particularly denote the flow path between an outlet of the pump and an inlet of the separation column.

M2. The method according to the preceding method embodiment, wherein the step of injecting a sample without the metering device being part of the analytical path comprises the system assuming a first injection configuration, wherein the analytical path comprises the sample loop, the sample pickup means, and the seat, but not the metering device.

M3. The method according to any of the preceding method embodiments, wherein the step of injecting a sample without the metering device being part of the analytical path further comprises decompressing the metering device to ambient pressure; and subsequently pressurizing the metering device to system pressure.

This may advantageously allow to keep the metering device at ambient pressure during sample analysis and at the same time avoid pressure fluctuations when switching the valve position, e.g. after analysis. It will be understood that system pressure relates to the pressure present at the separation column, particularly at the inlet of the separation column.

M4. The method according to any of the preceding method embodiments, wherein the step of injecting a sample with the metering device being part of the analytical path comprises the system assuming a second injection configuration, wherein the analytical path comprises the metering device, the sample loop, the sample pickup means and the seat.

M5. The method according to any of the preceding method embodiments, wherein the step of injecting a sample with the metering device being part of the analytical path comprises adjusting the gradient delay volume in the analytical path by means of the metering device.

M6. The method according to any of the preceding method embodiments, wherein the hardware of the system including comprised parts, components and the respective tubing are not manually changed during the method.

M7. The method according to any of the preceding method embodiments, wherein the method further comprises equilibrating the separation column with solvent provided by the pump.

M8. The method according to the preceding method embodiment, wherein equilibrating the separation column comprises the system assuming an equilibration configuration wherein the analytical path does not comprise the metering device, the sample loop, the sample pickup means or the seat.

M9. The method according to any of the preceding method embodiments, wherein the method further comprises picking up a sample and storing it in the sample loop.

M10. The method according to the preceding method embodiment, wherein the step of picking up the sample and storing it comprises the system assuming a sample-pickup configuration, wherein the metering device is fluidly connected to a dead end, and to the sample loop and the sample pickup means, and wherein the sample pickup means is separated from the seat and moved to a sample vial.

M11. The method according to any of the 2 preceding method embodiments, wherein the step of picking up the sample and storing it comprises separating the sample pickup means from the seat and moving it to a sample vial.

M12. The method according to any of the 3 preceding method embodiments, wherein the step of picking up the sample and storing it comprises drawing in at least a portion of sample from a sample vial into the sample loop by means of the metering device.

M13. The method according to any of the 4 preceding method embodiments, wherein the step of picking up the sample and storing it comprises repeatedly drawing in a portion of sample from a sample vial into the sample loop, with interrupted draining of solvent from the metering device.

M14. The method according to any of the 5 preceding method embodiments, wherein the step of picking up the sample and storing it comprises drawing in a first portion of sample from a sample vial into the sample loop by means of the metering device, draining of solvent from the metering device to a waste, and drawing in a second portion of sample from a sample vial into the sample loop by means of the metering device.

M15. The method according to any of the 6 preceding method embodiments, wherein the step of picking up the sample and storing it comprises the system assuming a sample-pickup configuration, drawing in a first portion of sample from a sample vial into the sample loop by means of the metering device, the system assuming a configuration wherein the metering device is fluidly connected to waste and to a dead end, draining of solvent from the metering device to a waste, and the system assuming the sample-pickup configuration, drawing in a second portion of sample from a sample vial into the sample loop by means of the metering device.

M16. The method according to any of the 7 preceding method embodiments, wherein the method comprises providing an uninterrupted solvent flow to the separation column during the step of picking up the sample and storing it.

M17. The method according to any of the 8 preceding method embodiments, wherein picking up a sample and storing it comprises drawing in at least a portion of sample from a sample vial into the sample loop by means of the metering device, draining solvent from the metering device to a waste, and drawing in at least a portion of a fluid other than sample from a vial into the sample loop by means of the metering device.

This may for example allow to dilute a sample. It will be understood that also multiple portions of sample and fluid other than sample may be drawn into the sample loop, e.g. in an alternating manner. Such a fluid other than sample may particularly be a solvent.

M18. The method according to any of the preceding method embodiments, wherein the method further comprises pre-compressing a sample stored in the sample loop.

M19. The method according to the preceding method embodiment, wherein the step of pre-compressing the sample comprises pressurizing the sample to system pressure by means of the metering device.

M20. The method according to any of the 2 preceding method embodiments, wherein the step of pre-compressing the sample comprises the system assuming a sample-precompression configuration, wherein the metering device is fluidly connected to the sample loop and the sample pickup means, which is received by the seat, and both the seat and the metering device are each fluidly connected to a dead end, such that the metering device can pressurize the sample loop.

M21. The method according to any of the preceding method embodiments, wherein the method further comprises washing, refilling and/or equilibrating metering device, seat, sample pickup means, sample loop, injection valve and/or separation column.

M22. The method according to the preceding method embodiment, wherein the step of washing, refilling and/or equilibrating comprises assuming a second injection configuration wherein the analytical path comprises the metering device, the sample loop, the sample pickup means and the seat. such that metering device, seat, sample pickup means sample loop, at least the ports and connecting elements of the injection valve which are part of the analytical flow path when assuming the second injection configuration, and the separation column are fluidly connected to the pump and can be provided with solvent.

M23. The method according to any of the preceding method embodiments, wherein the method further comprises decompressing the sample loop, the seat, the sample pickup means and the metering device after sample injection and/or the step of washing, refilling and/or equilibrating.

M24. The method according to the preceding method embodiment, wherein the step of decompressing comprises assuming a sample-precompression configuration.

M25. The method according to any of the preceding method embodiments, wherein the method further comprises detecting sample constituents in an effluent of the separation column.

M26. The method according to any of the preceding method embodiments, wherein the method comprises purging the pump.

M27. The method according to the preceding method embodiment, wherein the step of purging the pump comprises the system assuming a pump-purge configuration wherein the pump is fluidly connected to waste.

M28. The method according to any of the preceding method embodiments, wherein the method comprises washing the metering device.

M29. The method according to the preceding method embodiment, wherein the step of washing the metering device comprises providing a solvent flow through the metering device, which is preferably subsequently guided to waste.

M30. The method according to any of the 2 preceding method embodiments, wherein the step of washing the metering device comprises the system assuming a metering-device wash configuration, wherein the metering device is fluidly connected to the pump and to waste.

M31. The method according to any of the preceding method embodiments, wherein the method comprises performing system diagnostics to detect leaks within the system.

M32. The method according to the preceding method embodiment, wherein performing system diagnostics comprises performing a leak test for the sample pickup means, the seat and the sample loop.

M33. The method according to the preceding method embodiment, wherein performing the leak test for the sample pickup means, the seat and the sample loop comprises pressurizing the sample loop, the sample pickup means and the seat by means of the pump.

M34. The method according to any of the 2 preceding method embodiments, wherein performing the leak test for the sample pick up means, the seat and the sample loop comprises the system assuming a first leak-test configuration, wherein the pump is fluidly connected to a dead end said fluid connection comprises the sample pickup means, the seat and the sample loop but not the metering device or the separation column.

M35. The method according to any of the 4 preceding method embodiments, wherein performing system diagnostics comprises performing a leak test for the metering device.

M36. The method according to the preceding method embodiment, wherein performing the leak test for the metering device comprises pressurizing the metering device by means of the pump.

M37. The method according to any of the 2 preceding method embodiments, wherein performing the leak test for the metering device comprises the system assuming a second leak-test configuration, wherein the pump is fluidly connected to a dead end and said fluid connection comprises the metering device but not the sample loop, the sample pickup means, the seat or the separation column.

M38. The method according to any of the preceding method embodiments and with the features of M31, wherein performing system diagnostics comprises performing a leak test for the pump.

M39. The method according to the preceding method embodiment, wherein performing the leak test for the pump comprises pressurizing the pump, particularly at the pump outlet

M40. The method according to any of the 2 preceding method embodiments, wherein performing the leak test for the pump comprises the system assuming a third leak-test configuration, wherein the pump is fluidly connected to a dead end, without the metering device, the sample loop, the sample pickup means, the seat or the separation column being part of said fluid connection.

M41. The method according to any of the preceding method embodiments and with the features of M31, wherein performing system diagnostics comprises performing a leak test for an injection path comprising the metering device, the sample loop, the sample pickup means and the seat.

M42. The method according to the preceding method embodiment, wherein performing a leak test for the injection path comprises pressurizing the injection path with the pump.

M43. The method according to any of the 2 preceding method embodiments, wherein performing the leak test for the injection path comprises the system assuming a fourth leak-test configuration, wherein the pump is fluidly connected to a dead end and wherein said fluid connection comprises the seat, the sample pickup means, the sample loop and the metering device, but not the separation column.

M44. The method according to any of the preceding method embodiments and with the features of at least one of M32, M35, M38, and M41, wherein performing the respective leak test comprises pressurizing a flow path to a desired operating pressure, and monitoring a decay of the once established pressure over a period of time to quantify an amount of leakage.

M45. The method according to any of the preceding method embodiments and with the features of at least one of M32, M35, M38, and M41, wherein performing the respective leak test comprises pressurizing a flow path to a desired operating pressure, maintaining the operating pressure over a period of time, and monitoring a required piston movement of the pump to quantify an amount of leakage.

M46. The method according to any of the preceding method embodiments and with the features of M8 and M10, wherein the method comprises maintaining a fluidic connection of the pump to the separation column while switching from the system assuming the equilibration configuration to the system assuming the sample-pickup configuration.

M47. The method according to any of the preceding method embodiments and with the features of M10 and M20, wherein the method comprises maintaining a fluidic connection of the pump to the separation column while switching from the system assuming the sample-pickup configuration to the system assuming the sample-precompression configuration.

Below, reference will be made to chromatography system embodiments. These embodiments are abbreviated by the letter “S” followed by a number. Whenever reference is herein made to “system embodiments”, these embodiments are meant.

S1. A chromatography system comprising
an injection valve (10) comprising at least 6 ports,
a pump (20),
a separation column (30),
a metering device (40),
a sample loop (50),
a sample pickup means (62), and
a seat (64) configured to receive and fluidly connect to the sample pick up means (62);
wherein the system is configured to assume a first injection configuration (I₁), wherein an outlet of the pump (20) is fluidly connected to an inlet of the separation column (30) and wherein a resulting flow path between the pump (20) and the separation column comprises the sample loop (50), the sample pickup means (62), and the seat (64), but not the metering device (40); and
wherein the system is configured to assume a second injection configuration (I₂), wherein the outlet of the pump (20) is fluidly connected to the inlet of the separation column (30) and wherein a resulting flow path between the pump (20) and the separation column comprises the metering device (40), the sample loop (50), the sample pickup means (62) and the seat (64).

The chromatography system may simply also be referred to as the system.

S2. The chromatography system according to the preceding system embodiment, wherein the outlet of the pump (20) is directly fluidly connected to a first port (102) of the injection valve (10).

It will be understood that a component being directly fluidly connected to another component is defined as no other port or connecting element of the injection valve being part of said fluidic connection.

S3. The chromatography system according to any of the preceding system embodiments, wherein an inlet of the pump (10) is fluidly connected to at least one solvent reservoir.

S4. The chromatography system according to any of the preceding system embodiments, wherein the pump (20) is configured to provide fluid at pressures of at least up to 200 bar, preferably at least up to 500 bar, more preferably at least up to 1000 bar, even more preferably at least up to 1500 bar.

S5. The chromatography system according to any of the preceding system embodiments, wherein the inlet of the separation column (30) is directly fluidly connected to a second port (104) of the injection valve (10).

S6. The chromatography system according to any of the preceding system embodiments, wherein the system further comprises a detector and wherein an outlet of the separation column is fluidly connected to an inlet of the detector.

S7. The chromatography system according to any of the preceding system embodiments, wherein a device inlet of the metering device (40) is directly fluidly connected to a fourth port of the injection valve (10); and a device outlet of the metering device (40) is directly fluidly connected to a fifth port of the injection valve (10).

It will be understood that the terms “device inlet” and “device outlet” do not restrict the metering device 40 to a single direction of flow, but rather serve to distinguish the two connections of the metering device. That is, the “device inlet” and the “device outlet” may both serve to receive and to provide fluid.

S8. The chromatography system according to any of the preceding system embodiments, wherein the metering device comprises a housing (42) and a piston (44), wherein the piston can be moved within the housing to provide a negative or positive pressure for moving fluids.

S9. The chromatography system according to any of the preceding system embodiments, wherein the metering device is a syringe.

S10. The chromatography system according to any of the 2 preceding system embodiments, wherein the metering device comprises a drive for moving the piston.

For example, the metering device may comprise a stepper motor or other drive device for moving the piston.

S11. The chromatography system according to any of the preceding system embodiments, wherein a first loop end of the sample loop (50) is directly fluidly connected to a third port of the injection valve, a second loop end of the sample loop (50) is directly fluidly connected to the sample pick up means (62), and the seat is directly fluidly connected to a sixth port of the injection valve (10).

S12. The chromatography system according to any of the preceding system embodiments, wherein the sample pickup means is a needle and the seat is a needle seat.

S13. The chromatography system according to any of the preceding system embodiments, wherein the injection valve is a shear valve.

S14. The chromatography system according to any of the preceding system embodiment, wherein the injection valve comprises a rotor and a stator.

S15. The chromatography system according to the preceding system embodiment, wherein all ports of the injection valve are comprised by the stator.

S16. The chromatography system according to any of the preceding system embodiments, wherein the injection valve comprises at least four connecting elements.

S17. The chromatography system according to the preceding system embodiment and with the features of S14, wherein the connecting elements are grooves in the stator or rotor.

S18. The chromatography system according to any of the 2 preceding system embodiments and with the features of S14, wherein all connecting elements are comprised by the rotor.

S19. The chromatography system according to any of the preceding system embodiments, wherein the injection valve comprises at most seven ports.

S20. The chromatography system according to any of the preceding system embodiments, wherein the system further comprises a waste.

S21. The chromatography system according to the preceding system embodiment, wherein the waste is directly fluidly connected to a seventh port of the injection valve (10).

S22. The chromatography system according to any of system embodiments S1 to S19, wherein the injection valve comprises exactly six ports.

S23. The chromatography system according to any of the preceding system embodiments, wherein the system comprises only a single injection valve directly involved in the sample injection.

That is a single injection valve that enables establishing of the fluidic connections required for injecting the sample. That is, switching from a picking up a sample and/or recompressing a sample to either one of the injection positions merely requires changing the valve position of the single injection valve.

S24. The chromatography system according to any of the preceding system embodiments, wherein the system comprises a controller configured to control the system during operation.

S25. The chromatography system according to the preceding system embodiment, wherein the controller is operatively connected to the injection valve, the sample pickup means, the pump and the metering device.

S26. The chromatography system according to any of the preceding system embodiments, wherein in the first injection configuration I₁ the resulting flow path between the pump and the separation column does not comprise dead volume within the injection valve.

S27. The chromatography system according to any of the preceding system embodiments and with the features of S16, wherein in the first injection configuration I₁ there is no dead volume in the connecting elements of the injection valve comprised by the resulting flow path between the pump and the separation column.

S28. The chromatography system according to any of the preceding system embodiments and with the features of S2, S5 and S11, wherein in the first injection configuration I₁ the first port is fluidly connected to the third port and the second port is fluidly connected to the sixth port or vice-versa, wherein the connection is solely established within the injection valve.

S29. The chromatography system according to any of the preceding system embodiments, wherein in the second injection configuration I₂ the resulting flow path between the pump and the separation column does not comprise dead volume within the injection valve downstream of the sample loop.

S30. The chromatography system according to any of the preceding system embodiments and with the features of S16, wherein in the second injection configuration I₂ there is no dead volume in the connecting element(s) of the injection valve comprised by the resulting flow path between the pump and the separation column downstream of the sample loop.

S31. The chromatography system according to any of the preceding system embodiments, wherein in the second injection configuration I₂ the metering device is located upstream of the sample loop.

S32. The chromatography system according to any of the preceding system embodiments and with the features of S2, S5, S7 and S11, wherein in the second injection configuration I₂ one of the fourth port and the fifth port is fluidly connected to the first port, while the remaining of the two is fluidly connected to the sixth port or the third port, and the second port is connected to the other one of the sixth port and the third port, wherein the respective connections are solely established within the injection valve.

S33. The chromatography system according to any preceding system embodiments, wherein the system is further configured to assume an equilibration configuration designed for equilibration of the separation column.

S34. The chromatography system according to the preceding system embodiment, wherein in the equilibration configuration the outlet of the pump is fluidly connected to the inlet of the separation column without the metering device, the sample loop, the sample pickup means or the seat being part of the respective connection.

S35. The chromatography system according to any of the 2 preceding system embodiments and with the features of S16, wherein in the equilibration configuration the outlet of the pump is fluidly connected to the inlet of the separation column via a single connecting element.

S36. The chromatography system according to any of the 3 preceding system embodiments and with the features of S2 and S5, wherein in the equilibration configuration the first port is fluidly connected to the second port solely within the injection valve.

S37. The chromatography system according to any of the 4 preceding system embodiments, wherein in the equilibration configuration a flow path between the pump and the separation column does not comprise dead volume within the injection valve.

S38. The chromatography system according to any of the 5 preceding system embodiments and with the features of S16, wherein in the equilibration configuration there is no dead volume in the connecting element of the injection valve comprised by a flow path between the pump and the separation column.

S39. The chromatography system according to any of the preceding system embodiments, wherein the system is further configured to assume a sample-pickup configuration designed for picking up a sample with the sample pickup means and storing it in the sample loop.

S40. The chromatography system according to the preceding system embodiment, wherein in the sample-pickup configuration the metering device is fluidly connected to the sample loop and the sample pickup means, and wherein the sample pickup means is separated from the seat and moved to a sample vial.

S41. The chromatography system according to any of the 2 preceding system embodiments, wherein in the sample-pickup configuration the pump is still fluidly connected to the separation column.

S42. The chromatography system according to any of the 3 preceding system embodiments and with the features of S2 and S5, wherein in the sample-pickup configuration the first port is fluidly connected to the second port solely within the injection valve.

S43. The chromatography system according to any of the 4 preceding system embodiments, wherein in the sample-pickup configuration one of a device inlet of the metring device and a device outlet of the metering device is fluidly connected to a dead end such that the metering device can provide a negative pressure for drawing in a sample from the sample vial.

S44. The chromatography system according to any of the 5 preceding system embodiments and with the features of S7 and S11, wherein in the sample-pickup configuration the fourth or the fifth port is fluidly connected to the sixth port solely within the injection valve and wherein the other one of the two is blocked or connected to a dead end.

S45. The chromatography system according to any of the preceding system embodiments, wherein the system is further configured to assume a sample-precompression configuration designed to pressurize a sample in the sample loop to system pressure.

S46. The chromatography system according to the preceding system embodiment, wherein in the sample-precompression configuration the metering device is fluidly connected to the sample loop, the sample pickup means is received by the seat and both the seat and the metering device are each fluidly connected to a dead end, such that the metering device can pressurize the sample loop.

S47. The chromatography system according to any of the 2 preceding system embodiments, wherein in the sample-precompression configuration the pump is still fluidly connected to the separation column.

S48. The chromatography system according to any of the 3 preceding system embodiments and with the features of S2 and S5, wherein in the sample-precompression configuration the first port is fluidly connected to the second port solely within the injection valve.

S49. The chromatography system according to any of the 4 preceding system embodiments and with the features of S7 and S11, wherein in the sample-precompression configuration the fourth or the fifth port is fluidly connected to the sixth port solely within the injection valve and wherein the other one of the two is blocked or connected to a dead end, and the sixth port is blocked or connected to a dead end.

S50. The chromatography system according to any of the preceding system embodiments, wherein the system is further configured to assume a pump-purge configuration designed for purging the pump.

S51. The chromatography system according to the preceding system embodiment and with the features of S20, wherein in the pump-purge configuration the pump is fluidly connected to waste.

S52. The chromatography system according to any of the 2 preceding system embodiments and with the features of S2 and S21, wherein in the pump-purge configuration the first port is fluidly connected to the seventh port solely within the injection valve.

S53. The chromatography system according to any of the preceding system embodiments, wherein the system is further configured to assume a metering-device wash configuration designed for washing the metering device.

S54. The chromatography system according to the preceding system embodiment and with the features of S20, wherein in the metering-device wash configuration the metering device is fluidly connected to the pump and to waste.

S55. The chromatography system according to any of the 2 preceding system embodiments and with the features of S2, S7 and S21, wherein in the metering-device wash configuration one of the fourth port and the fifth port is fluidly connected to the first port solely within the injection valve and the other one of the fourth port and the fifth port is fluidly connected to the seventh port solely within the injection valve.

S56. The chromatography system according to any of the preceding system embodiments wherein the system is further configured to assume a first leak-test configuration designed to pressurize the sample pickup means, the seat and the sample loop by means of the pump.

S57. The chromatography system according to the preceding system embodiment, wherein in the first leak-test configuration the pump is fluidly connected to a dead end, wherein the respective fluid connection comprises the sample loop, the sample pickup means and the seat but not the metering device.

S58. The chromatography system according to any of the 2 preceding system embodiments and with the features of S2 and S11, wherein in the first leak-test configuration the first port is fluidly connected to one of the third port and the sixth port solely within the injection valve and wherein the other one of the third port and the sixth port is blocked or fluidly connected to a dead end solely within the injection valve.

S59. The chromatography system according to any of the preceding system embodiments, wherein the system is further configured to assume a second leak-test configuration designed to pressurize the metering device.

S60. The chromatography system according to the preceding system embodiment, wherein in the second leak-test configuration the pump is fluidly connected to a dead end, wherein the respective fluid connection comprises the metering device but not the sample loop, the sample pickup means, the seat or the separation column.

S61. The chromatography system according to any of the 2 preceding system embodiments and with the features of S2 and S7, wherein in the second leak-test configuration the first port is fluidly connected to one of the fourth port and the fifth port solely within the injection valve and wherein the other one of the fourth port and the fifth port is blocked or fluidly connected to a dead end solely within the injection valve.

S62. The chromatography system according to any of the preceding system embodiments, wherein the system is further configured to assume a third leak-test configuration designed to pressurize the pump, particularly at the pump outlet.

S63. The chromatography system according to the preceding system embodiment, wherein in the third leak-test configuration the pump is fluidly connected to a dead end, without the metering device, the sample loop, the sample pickup means, the seat or the separation column being part of the respective fluid connection.

S64. The chromatography system according to any of the 2 preceding system embodiments and with the features of S2, wherein in the third leak-test configuration the first port is blocked or fluidly connected to a dead end solely within the injection valve.

S65. The chromatography system according to any of the preceding system embodiments, wherein the system is further configured to assume a fourth leak-test configuration designed to pressurize the seat, the sample pickup means, the sample loop, and the metering device.

S66. The chromatography system according to the preceding system embodiment, wherein in the fourth leak-test configuration the pump is fluidly connected to a dead end, wherein the respective fluid connection comprises the seat, the sample pickup means, the sample loop and the metering device, but not the separation column.

S67. The chromatography system according to any of the 2 preceding system embodiments and with the features of S2, S7 and S11, wherein in the fourth leak-test configuration the first port is fluidly connected to one of the third port and the sixth port solely within the injection valve the other one of the third port and the sixth port is fluidly connected to the fourth port or the fifth port solely within the injection valve, and the other one of the fourth port and the fifth port is blocked or fluidly connected to a dead end solely within the injection valve.

S68. The chromatography system according to any of the preceding system embodiments, wherein the chromatography system is a liquid chromatography system.

S69. The chromatography system according to any of the preceding system embodiments, wherein the chromatography system is a high-performance liquid chromatography system.

S70. The chromatography system according to any of the preceding system embodiments, wherein the system is configured to operate at fluid pressures of at least up to 200 bar, preferably at least up to 500 bar, more preferably at least up to 1000 bar, even more preferably at least up to 1500.

S71. The system according to any of the preceding system embodiments and with the features of S24, wherein the controller is configured to perform the method according to any of the preceding method embodiments.

S72. The system according to any of the preceding system embodiments and with the features of S33 and S39, wherein the system is configured to switch between assuming the equilibration configuration and assuming the sample-pickup configuration without disconnecting the pump from the separation column.

S73. The system according to any of the preceding system embodiments and with the features of S39 and S45, wherein the system is configured to switch between assuming the sample-pickup configuration and assuming the sample-precompression configuration without disconnecting the pump from the separation column.

M48. The method according to any of the preceding method embodiments, wherein the chromatography system is a chromatography system according to any of the preceding system embodiments.

M49. The method according to any of the preceding method embodiments, wherein the configurations assumed by the system are the configurations as defined in the preceding system embodiments.

Below, reference will be made to computer program product embodiments. These embodiments are abbreviated by the letter “C” followed by a number. Whenever reference is herein made to “program embodiments”, these embodiments are meant.

C1. Computer program product comprising instructions which, when the program is executed by the controller of a chromatography system according to system embodiment S24, cause the controller to operate the chromatography system according to any of the preceding method embodiments.

Embodiments of the present invention will now be described with reference to the accompanying drawings. These embodiments should only exemplify, but not limit, the present invention.

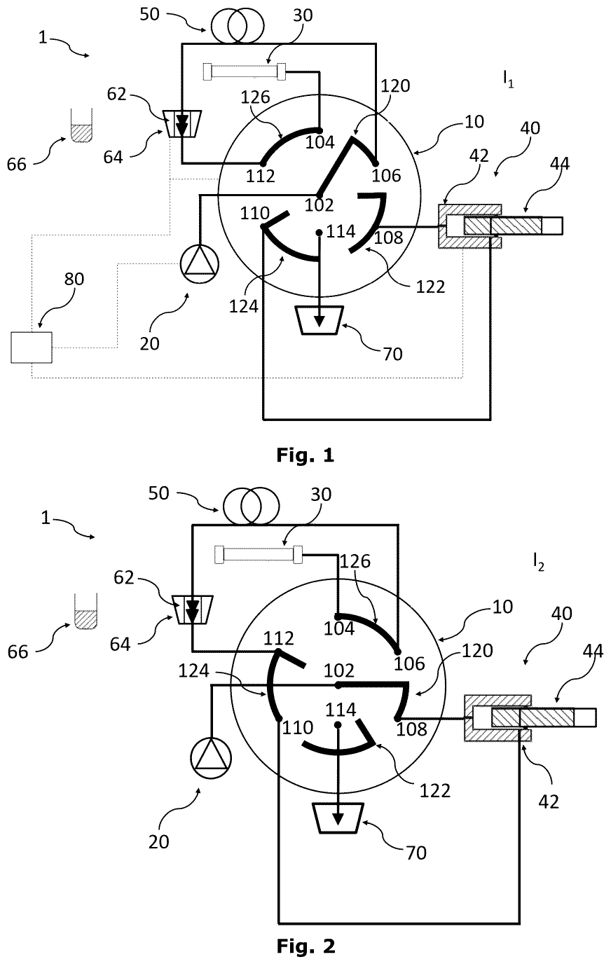

FIG. 1 depicts an exemplary embodiment of a chromatography system assuming the first injection configuration;

FIG. 2 depicts the exemplary embodiment of the chromatography system assuming the second injection configuration;

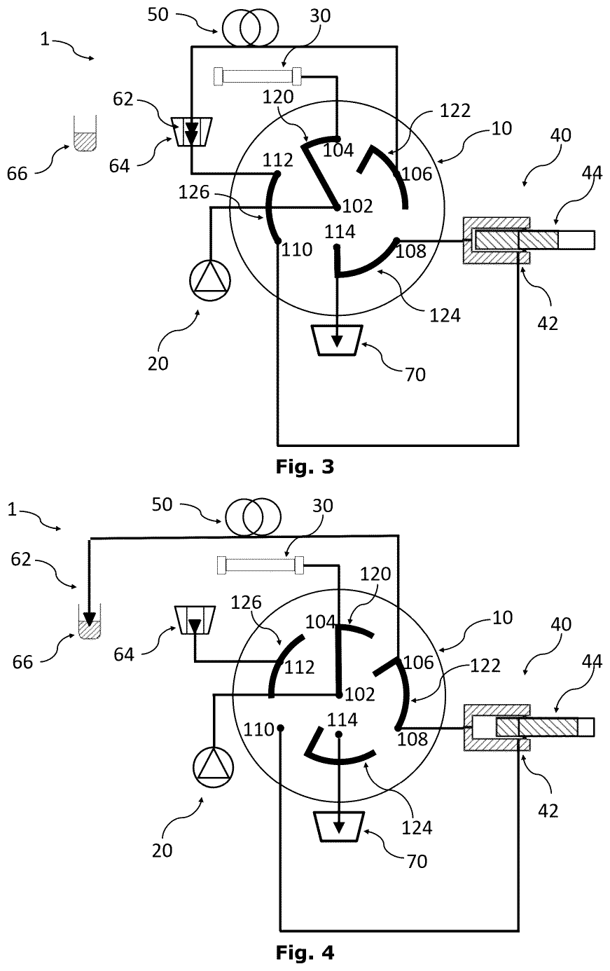

FIG. 3 depicts the exemplary embodiment of the chromatography system assuming the equilibration configuration;

FIG. 4 depicts the exemplary embodiment of the chromatography system assuming the sample-pickup configuration;

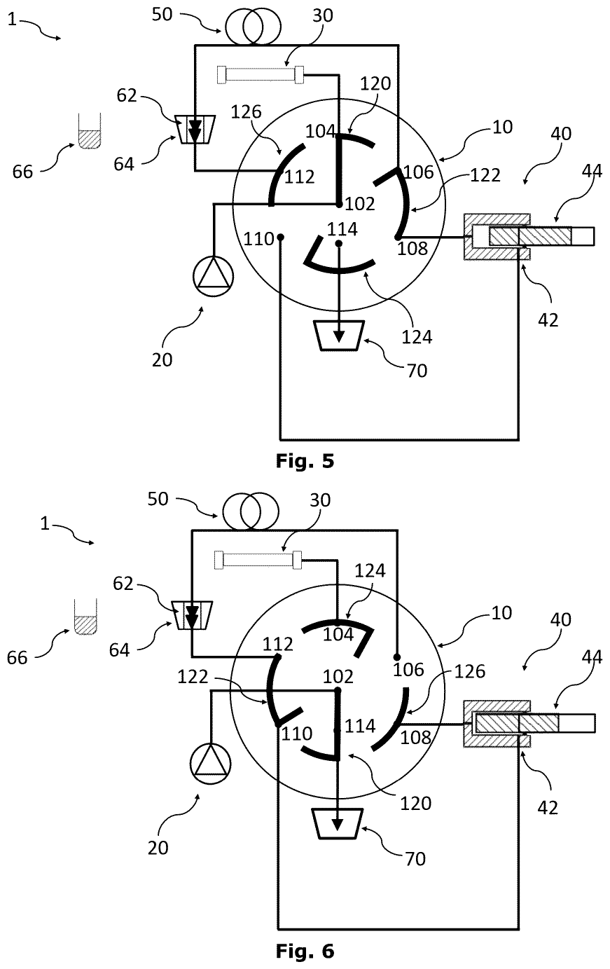

FIG. 5 depicts the exemplary embodiment of the chromatography system assuming the sample-precompression configuration;

FIG. 6 depicts the exemplary embodiment of the chromatography system assuming the pump-purge configuration;

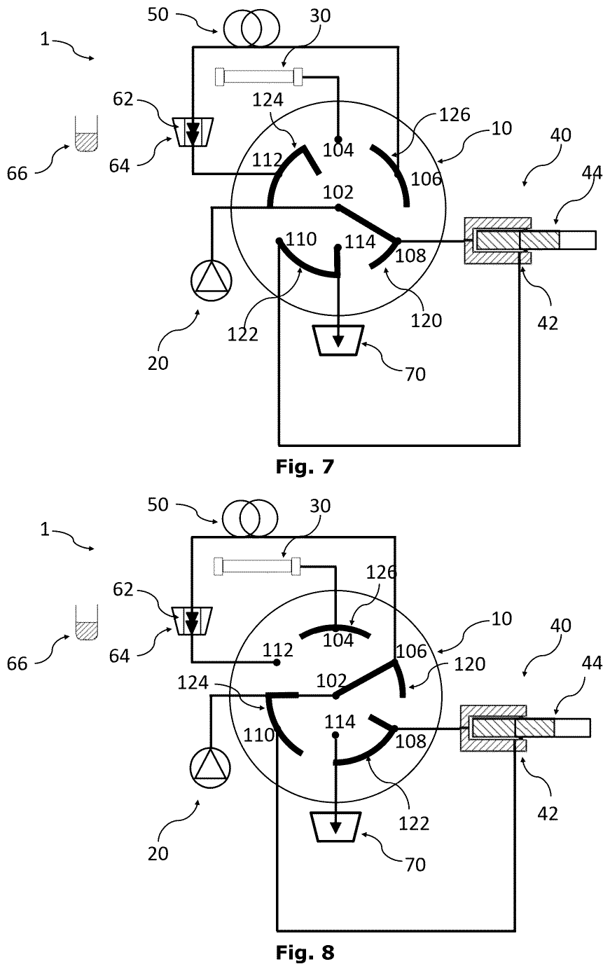

FIG. 7 depicts the exemplary embodiment of the chromatography system assuming the metering-device wash configuration;

FIG. 8 depicts the exemplary embodiment of the chromatography system assuming the first leak-test configuration;

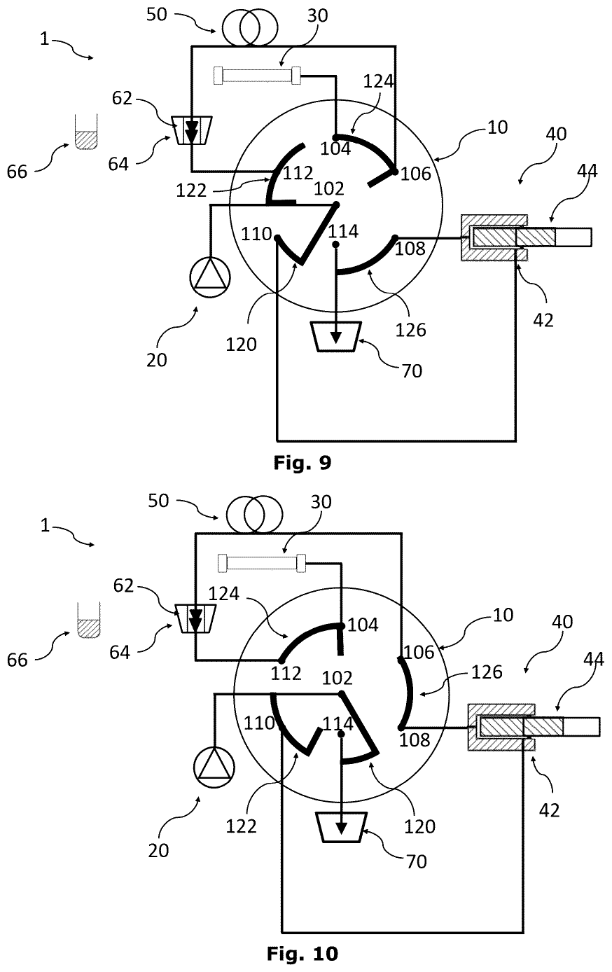

FIG. 9 depicts the exemplary embodiment of the chromatography system assuming the second leak-test configuration;

FIG. 10 depicts the exemplary embodiment of the chromatography system assuming the third leak-test configuration;

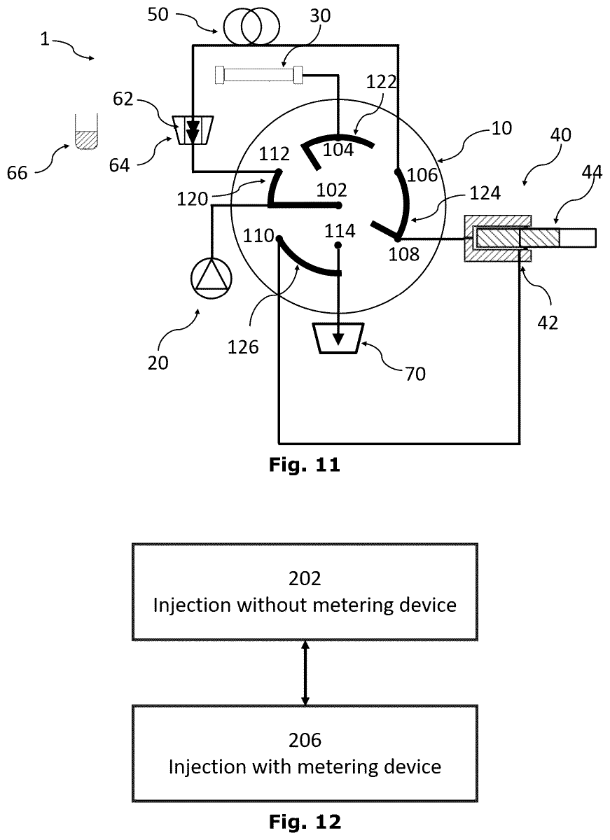

FIG. 11 depicts the exemplary embodiment of the chromatography system assuming the fourth leak-test configuration;

FIG. 12 depicts an exemplary embodiment of a method according to the present invention;

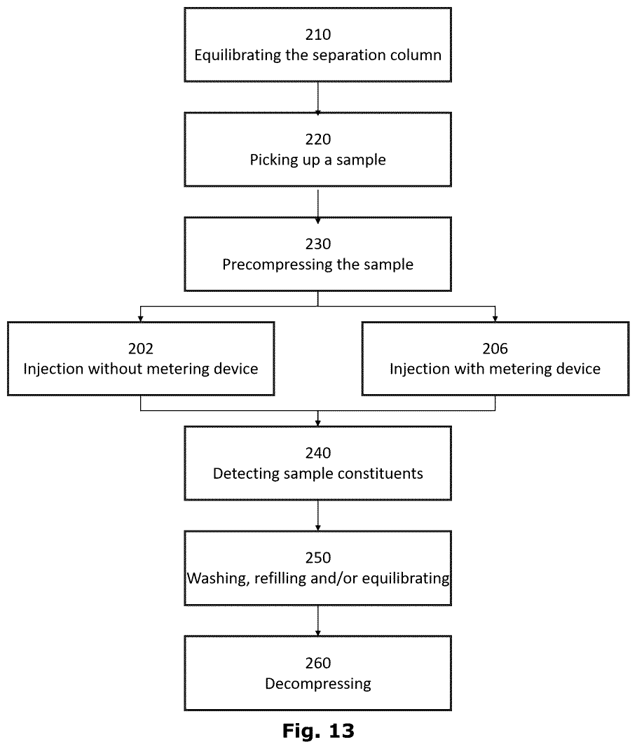

FIG. 13 depicts another exemplary embodiment of a method according to the present invention; and

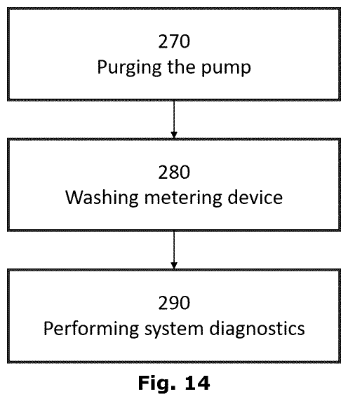

FIG. 14 depicts optional additional method steps.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

In one embodiment, the invention relates to a chromatography system 1 comprising a distribution valve 10, a pump 20, a separation column 30, a metering device 40 and a sample loop 50. The distribution valve 10 may also be referred to as injection valve 10 since it is directly involved in the injection, particularly it enables establishing the fluidic connections for injecting a sample.

With reference to FIG. 1, a chromatography system 1 may further comprise a sample pickup means 62, e.g. a needle 62, and a seat 64, e.g. a needle seat 64, configured to receive the sample pickup means 62. Additionally, the chromatography system may also comprise a waste 70. It will be understood that the chromatography system may further comprise a plurality of tubes to establish fluid connections between different components of the system.

The injection valve 10 may be a shear valve, particularly it may comprise a stator, a rotor and a rotatable drive. The stator may comprise at least 6 ports 102, 104, 106, 108, 110, 112, 114 furthermore stator and rotor may comprise connecting elements 120, 122, 124, 126 (e.g. grooves) to connect the ports to one another. Preferably, these connecting elements may solely be located in the rotor. The rotor can be rotated with respect to the stator (by means of the rotatable drive) so that the connecting elements may establish connections between different ports. The rotatable drive can include a motor, gearbox, and encoder.

It should be understood that the connecting elements 120, 122, 124, 126 are configured to connect ports 102, 104, 106, 108, 110, 112, 114 to one another. For example, in the configuration depicted in FIG. 1, connecting element 126 connects ports 104 and 112, and connecting element 120 connects ports 102 and 106, but port 114 is not connected to another port in the configuration depicted in FIG. 1, as no connecting element is connected to this port 114. Similarly, it should be understood that, e.g., in FIG. 3, connecting element 120 connects the ports 102 and 104, connecting element 126 connects the ports 110 and 112, and connecting element 124 connects the ports 108 and 114, but connecting element 126 is not connected, e.g., to port 102 in the configuration depicted in FIG. 3.

Generally, the metering device 40 may comprise a housing 42 and a piston 44. The metering device 40 may also be referred to as sampling device 40. The metering device may also comprise a stepper motor or a drive device for moving the piston 44 in the housing 42. The metering device 40 may for example be a motorized syringe.

Furthermore, the system 1 may also comprise a controller 80 as depicted in FIG. 1. For sake of simplicity and readability the controller 80 may be omitted in the following Figures. The controller 80 can be operatively connected to other components, as depicted by dashed lines in FIG. 1. More particularly, the controller 80 may be operatively connected to the injection valve 10 (and more particularly to the rotatable drive thereof), to the sample pickup means 62, to the pump 20, and to the metering device 40 (more particularly, to the stepper motor or drive device of the metering device 40).

The controller 80 can include a data processing unit and may be configured to control the system 1 and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

Furthermore, it should be understood that the system 1 may be configured to measure pressures at different locations of the system. For example, the system may comprise a plurality of pressure sensors. For example, a first pressure sensor may be located in or at the pump 20, and a second pressure sensor may be located in the metering device 40. These pressure sensors may also be operatively connected to the controller 80, and the controller 80 may use readings of these pressure sensors when controlling the operation of the system 1. The pressure sensors may be configured to measure the pressure directly. However, it should be understood that also other parameters may be measured and may be used to determine the respective pressures (and that such a procedure should also be understood as a pressure measurement and the components involved should be understood as pressure sensors). For example, it will be understood that when a pump 20 supplies a solvent at a flow rate, the power consumption of the pump 20 will also depend on the pressure at which it operates-the higher the operating pressure, the higher the power consumption. Thus, e.g., the power consumption of the pump 20 may also be used to derive the pressure present at the pump 20. A corresponding consideration also applies for the metering device 40: The higher the pressure present in the metering device 40, the higher the power consumption when the piston 44 is moved further into the housing 42. Thus, the system 1 may generally be configured to measure pressures present at different locations of the system 1. It will be understood that pressures may also be calculated based on given parameters such as volume, compressibility and initial pressure.

With reference to FIG. 1 an exemplary system 1 is shown, wherein the pump 20 may be directly fluidly connected to a first port 102 of the injection valve 10. In the context of this application being “directly fluidly connected to” another component means that no other port (or connection element) of the injection valve is part of said connection. An inlet of the pump 20 may be fluidly connected to at least one solvent reservoir (not shown). The pump 20 may for example be a binary pump or a quaternary pump fluidly connected to a plurality of solvent reservoirs and configured to provide a desired solvent composition.

Similarly, the separation column 30 may be directly fluidly connected to a second port 104. In particular, an inlet of the separation column 30 may be directly fluidly connected to the second port 104. An outlet of the separation column may be fluidly (preferably directly fluidly) connected to a detector. The detector may be comprised by the system and may be configured to analyse an effluent of the separation column.

The metering device 40 may be directly fluidly connected to a fourth and fifth port 108, 110. That is, a device outlet of the metering device 40 may be directly fluidly connected to a fifth port 110 and a device inlet of the metering device 40 may be directly fluidly connected to fourth port 108. It will be understood that the terms “device inlet” and “device outlet” do not restrict the metering device 40 to a single direction of flow, but rather serve to distinguish the two connections of the metering device. That is, the “device inlet” and the “device outlet” may both serve to receive and to provide fluid. For sake of simplicity, in the following the device inlet may also simply referred to as inlet and the device outlet may also simply be referred to as outlet.

The sample loop 50 may be directly fluidly connected to the third port 106 at a first end and a second end of the sample loop 50 may be directly fluidly connected to the sample pickup means 62 (i.e. without a port being within said fluid connection). The seat 64 for receiving the sample pickup means 62 may be directly fluidly connected to a sixth port 112. The sample pickup means 62 may be configured to be moved between the seat 64 and at least one sample vial 66. Thus, the system 1 may comprise a split-loop configuration, wherein a sample may be loaded into the sample loop 50 by separating the sample pickup means 62 from the seat 64 and moving it so a respective sample vial 66.

Additionally, the exemplary system in FIG. 1 may comprise a waste 70 directly fluidly connected to a seventh port 114.

Furthermore, the injection valve 10 may comprise a first connecting element 120, a second connecting element 122, a third connecting element 124 and a fourth connecting element 126. These connecting elements may preferably be grooves. Connecting elements may generally be located in the rotor and/or stator. Preferably, these connecting elements are located in the rotor of the injection valve 10. Thus, the connecting elements may be grooves in the rotor of the injection valve 10. The ports may preferably be located in the stator of the injection valve. Thus, the injection valve 10 may assume different valve positions by changing the relative position of the stator and the rotor, whereby different ports are connected by different connecting elements. In some valve positions at least some of the ports may also be blocked, i.e. not connected to another port via a connecting element.

In the exemplary embodiment depicted in the Figures, the first port 102 may be located in a centre of the stator and fluidly connected to the first connecting element 120 independent of the relative position of stator and rotor. The second 104, third 106, fourth 108, fifth 110 and sixth 112 port may all be located equally distanced to the centre of the stator, i.e. on a circular line centred on the centre of the stator. The optional seventh port 114 may be located further inwards, then the second to sixth port, i.e. it may be closer to the centre of the stator. The second 104, third 106, fourth 108, fifth 110, sixth 112 and seventh 114 port may be equally spaced in a circumferential direction, i.e. when projected on a single circular line centred on the centre of the stator.

The first connecting element 120, may generally be hook-shaped and dimensioned such that it can fluidly connect the first port 102, to any of the other ports. A longer portion of the hook-shaped first connecting element 120 may be running from the centre of the rotor outwards to the circular line in which the second to sixth port lie. A shorter portion of the first connecting element 120 may lie on said circular line.

The second 122 and third 124 connecting element may also be hook-shaped but dimensioned and oriented such that they can connect two adjacent ports on the circular line and/or either the fourth or fifth port to the seventh port. Thus, a longer portion of the second and third connecting element may be running along the circular line and a shorter portion may be directed towards the centre of the valve (rotor/stator).

The fourth connecting element 126 may be in the shape of an arc oriented along the circular line and dimensioned to fluidly connect two neighbouring ports.

The present invention enables the system to assume two distinct injection configurations—a first injection configuration I₁ with minimum GDV and a second injection configuration I₂ with adjustable GDV.

The system being configured to assume a certain configuration requires the system to be configured to actually assume the configuration and particularly a corresponding valve position for performing a certain task. A system which is merely suitable to generally assume a respective configuration without there being any technical measures to actually assume said configuration is not considered to be configured to assume said configuration. In particular, a valve that simply moves through a valve position that would be required to be assumed when assuming a respective configuration does not assume said position and thus the system does not assume said configuration and is also not configured to assume said configuration.

With reference to FIG. 1 the exemplary system is shown assuming the first injection configuration I₁, wherein the outlet of the pump 20 is fluidly connected to the inlet of the separation column 30 via the sample loop 50 and without the metering device 40 being part of said fluid connection. In other words, in the first injection configuration I₁ the sample loop 50, the sample pickup means 62 and the seat 64 are within an analytical flow path between the pump 20 and the separation column 30, while the metering device 40 is not within the analytical flow path and thus not in fluidic connection to the pump 20 and/or the separation column 30.

In the exemplary system embodiment, only the pump 20, the sample loop 50, the sample pickup means 62, the seat 64 and the first 102, second 104, third 106 and sixth 112 port as well as the third 124 and fourth 126 connecting element of the injection valve 10 are part of the analytical path upstream of the separation column 30. It will be understood that also the tubes for establishing the fluid connections are part of said analytical path. Generally, the first injection configuration I₁ allows for a reduced GDV compared to having the metering device 40 in the analytical path, and may for example be particularly suited for low flow analyses.

The metering device 40 may be fluidly disconnected from further components, e.g. the device outlet and the device inlet may be connected to dead ends, e.g. a blocked port or a connecting element not fluidly connected to another port. In the exemplary system embodiment, the fourth port 108 connected to the metering device inlet may be connected to the second connecting element 122 and the fifth port 110 connected to the metering device outlet may be connected to the third connecting element 124. The second 122 and third 124 connecting element are each not connected to any other port, such that the metering device 40 is fluidly disconnected.

During sample analysis the metering device 40 may be decompressed (i.e., brought to a lower and preferably ambient pressure) and subsequently compressed again to system pressure after the analysis. Such a controlled decompression and compression may advantageously allow to avoid pressure fluctuations when switching the valve position, e.g. after analysis, which may otherwise occur due to uncontrolled pressure loss in the metering device during long analysis due to leaks.

With reference to FIG. 2 the exemplary system is shown assuming the second injection configuration I₂, wherein the outlet of the pump 20 is fluidly connected to the inlet of the separation column 30 via the metering device 40, the seat 64, the needle 62 and the sample loop 50. In other words, in the second injection configuration I₂ both, sample loop 50 and metering device 40 are within the analytical flow path between the pump 20 and the separation column 30.

In the exemplary system embodiment, the pump 20, the metering device 40, the sample loop 50, the sample pickup means 62, the seat 64 and the first 102, second 104, third 106, fourth 108, fifth 110 and sixth 112 port as well as the first 120, third 124 and fourth 126 connecting element of the injection valve 10 are part of the analytical path upstream of the separation column 30. It will be understood that also the tubes for establishing the fluid connections are part of said analytical path. Generally, the second injection configuration I₂ allows for adjusting the GDV through movement of the piston 44 of the metering device, and may for example be particularly suited for emulating an older HPLC system.

Advantageously, the second injection configuration I₂ the metering device 40 may be constantly rinsed during the analysis, which may avoid formation of impurities, sample residues and solvent residues, which may otherwise occur (e.g., in the first injection configuration). Further to this, the second injection configuration may also be used for washing functions. In particular, the system may for example assume the second injection configuration I₂ after injecting a sample in the first injection configuration I₁ in order to wash components that are not comprised by the analytical path in the first injection configuration I₁, e.g. the metering device 40.

In the exemplary embodiment depicted in FIGS. 1 and 2, the conveying direction changes between the first injection configuration and the second injection configuration. That is, in the first injection configuration the sample is conveyed to the column via the sample pickup means 62 and the seat 64, whereas in the second injection configuration the sample is pushed through the entire sample loop (and not through the seat 64). However, it will be understood that other setups are conceivable that have the same conveying direction for both injection configurations or that the directions are reversed compared to the directions disclosed in FIGS. 1 and 2.

Thus, the present invention provides a system (and method) wherein the metering device 40 is either part of the analytical path during sample injection or not. In particular, no changes to the design of the injection valve are required, i.e. rotor and stator are identical for both injection configurations.

In addition to the two injection configurations, the system can also assume additional configurations as discussed in the following.

With reference to FIG. 3, the exemplary system can assume an equilibration configuration, which may also be referred to as idle configuration. In the equilibration configuration, the pump 20 may be fluidly connected to the separation column 30 via a single connecting element and particularly the first connecting element 120. That is, the first port 102 may be fluidly connected to the second port 104 solely via connecting element 120. This may allow to equilibrate the separation column 30 with a solvent provided by the pump 20.

More generally, the pump 20 may be fluidly connected to the separation column 30 without the sample loop, the sample pickup means 62, the seat 64 or the metering device 40 being part of said fluid connection. In other words, the pump and the separation column may be fluidly connected via a single connecting element of the injection valve. Preferably the fluid connection between pump and separation column may be dead-volume free within the injection valve, more preferably said fluid connection may be dead-volume free between the pump outlet and the separation column inlet.

The outlet of the metering device 40 may be fluidly connected to waste 70 by means of the third connecting element 124 fluidly connecting the fourth port 108 to the seventh port 114. The inlet of the metering device 40 may be fluidly connected to the seat 64, the sample pickup means 62 and the sample loop 50 by means of the fourth connecting element 126 fluidly connecting the fifth port 110 to the sixth port 112. More generally, the metering device may be fluidly connected to waste and to the seat, sample pickup means and sample loop.

With reference to FIG. 4, the system may be configured to assume a sample-pickup configuration, wherein the pump 20 may still be fluidly connected to the separation column 30 via the first connecting element 120, while the inlet of the metering device 40 may be fluidly connected to the sample loop 50 and the sample pickup means 62. That is the fourth port may be directly fluidly connected to the third port 106 by means of the second connecting element 122. The outlet of the metering device may not be fluidly connected to any other component, in particular the fifth port 110 may be blocked. This configuration allows for the sample pickup means 62 to be moved to a sample vial 66 and to subsequently suck a sample from the sample vial 66 into the sample loop 50 by moving the piston 44 of the metering device 40 out of the housing 42 to create the required negative pressure.

More generally, the pump 20 may still be fluidly connected to the separation column 30 without the sample loop, the sample pickup means 62, the seat 64 or the metering device 40 being part of said fluid connection. Thus, the pump and the separation column may still be fluidly connected via a single connecting element of the injection valve. However, in the sample-pickup configuration, the metering device may not be connected to waste, but one of the device inlet and the device outlet may be fluidly connected to a dead end, while the other end may be fluidly connected to the sample loop 50 and the sample pickup means 62, which may be detached from the seat 64 and moved to a sample vial 66.

In case there is a desire to analyse a larger sample, multiple portions of the sample can be drawn in with the solvent in the metering device 40 being drained in between. That is, after drawing in a portion of the sample in the sample-pickup configuration, the system may assume the equilibration configuration to drain the solvent within the metering device to waste 70 by moving the piston 44 into the housing 42. Subsequently the system can return to the sample-pickup configuration and draw in another portion of the sample. This can be repeated until sufficient amount of sample is stored in the sample loop 50. It will be understood that generally also other portions of fluids, such as liquids and particularly solvents may be picked up during such a multi-draw procedure, e.g. for sample dilution.

Once sample has been picked up into the sample loop, i.e. after the last time assuming the sample-pickup configuration, the system may assume a sample-precompression configuration by moving the sample pickup means 62 to the seat 64 (cf. FIG. 5). That is, the valve position may remain identical to the sample-pickup configuration. Since outlet of the metering device 40 and the seat 62 are both fluidly connected to a dead end, this configuration allows to bring the sample loop to system pressure by moving the piston 44 of the metering device 40 into the housing 42 to increase the pressure. This can advantageously allow to avoid pressure fluctuations when switching the sample loop 50 into the analytical path.

More generally, in the sample-precompression configuration the seat 64 may be fluidly connected to a dead end and may further receive the sample pickup means 62. The sample loop fluidly connected to the sample pickup means may further be fluidly connected to one of the device inlet or the device outlet of the metering device, while the other one of the two is fluidly connected to a dead end. Thus, a sample stored in the sample loop may be pressurized by means of the metering device.

Upon successful precompression of the sample loop, the system may then assume one of the two disclosed injection configurations (cf. FIGS. 1 and 2) depending on the present need. Once the sample has been successfully analysed the system can we washed and equilibrated, e.g. by assuming the second injection configuration I₂, prior to returning to the equilibration configuration, wherein the sample loop 50 and metering device 40 may be decompressed by moving the piston 44 of the metering device 40 out of the housing 42.

The system may also assume a pump-purge configuration, (cf. FIG. 6), wherein the pump 20 is fluidly connected to waste 70. Particularly, the first port 102 may be directly fluidly connected to the seventh port 114 by means of the first connecting element 120. That is, the pump 20 may be fluidly connected to waste 70 without the separation column 30, the metering device 40, the sample loop 50, the sample pickup means 62, or the seat 64 being part of said fluid connection. This configuration allows for purging the pump 20.

The system may also assume a metering-device wash configuration (cf. FIG. 7), wherein the pump 20 is fluidly connected to the device inlet of the metering device 40 and the device outlet of the metering device 40 is fluidly connected to waste. In particular the first port 102 may be directly fluidly connected to the fourth port 108 by means of the first connecting element 120 and the fifth port 110 may be directly fluidly connected to the seventh port 114 by means of the second connecting element 122. More generally, the pump 20 may be fluidly connected to waste 70, wherein the metering device is part of said fluid connection and without the sample loop, the sample pickup means, the seat or the separation column being part of said connection. This configuration may allow for washing the metering device 40. Additionally, the metering device 40 may be filled with solvent provided by the pump, e.g. the same solvent (or solvent composition) that is used for equilibrating the separation column 30.

Furthermore, the system may also assume leak test configurations that allow to test the system and more specifically certain components of the system for leaks. Generally, the system may assume leak test configurations and subsequently the pump 20 may be used to pressurize a respective portion of the system. In particular, the pump 20 may either compress a fluidic path connected to its outlet to a desired operating pressure and not readjust once said pressure has been reached, i.e. stop once the desired pressure has been reached. In this case, a drop of pressure over time may then be an indicator of an amount of leakage. Alternatively, the pump 20 may regulate to a desired operating pressure, i.e. maintain said desired operating pressure. In this case, a corrective movement of the piston may indicate an amount of leakage.

The system may assume a first leak-test configuration (cf. FIG. 8), wherein particularly the sample pickup means 62 and the seat 64 may be leak tested. It will be understood that this configuration also allows for leak testing of the sample loop 50 connected to the sample pickup means 62. In the first leak-test configuration the pump 20 may be fluid connected to the sample loop 50, while the seat 64 may be fluidly connected to a dead end. That is, in the exemplary system the first port 102 may be directly fluidly connected to the third port 106 by means of the first connecting element 120, while the sixth port 112 may be blocked. This may allow to build up pressure in the sample loop 50 and particularly the sample pickup means 62 and the seat 64 to check for any leaks.

More generally, in the first leak-test configuration the pump may be fluidly connected to a dead end, wherein the sample loop, the sample pickup means and the seat are comprised by said fluid connection, while the metering device or the separation column are not comprised by said fluid connection.

Further, the system may assume a second leak-test configuration (cf. FIG. 9), wherein the metering device 40 may be leak tested. In the second leak-test configuration the pump 20 may be fluidly connected to the outlet of the metering device 40 while the inlet of the metering device 40 is fluidly connected to a dead end. Particularly, the first port 102 may be directly fluidly connected to the fifth port 110 by means of the first connecting element 120, while the fourth port 108 is fluidly connected to the fourth connecting element 126, which is not connected to any other port or connecting element such that the fifth port is effectively blocked. Thus, the pump 20 may be used to pressurize the metering device 40 such that any leaks in the metering device (or associated tubing) may be detected.

More generally, in the second leak-test configuration the pump may be fluidly connected to a dead end, wherein the metering device is comprised by said fluid connection, while the sample loop, the sample pickup means, the seat or the separation column are not comprised by said fluid connection.

The system may assume a third leak-test configuration (cf. FIG. 10), wherein the outlet of the pump may be fluidly connected to a dead end to allow for leak testing of the pump 20. In particular, the first connecting element 102 fluidly connected to the first port 102 may not be fluidly connected to any other port or connecting element, such that first port is effectively blocked. This allows to detect any leaks in the pump or the fluid connection between the outlet of the pump and the injection valve or more specifically the first port 102. Since the pump 20 participates in any of the different leak tests, the third leak-test configuration may typically be assumed first to ensure tightness of the pump 20.

The system may assume a fourth leak-test configuration (cf. FIG. 11), wherein the pump 20 may be fluidly connected to the seat 64, the sample pickup means 62, the sample loop 50 and the inlet of the metering device 40, while the outlet of the metering device 40 may be connected to a dead end. This way, the whole injection path, i.e. the flow path comprising metering device 40, sample loop 50, sample pickup means 62 and seat 64 may be leak tested. That is the injection path may correspond to the flow path switched into the analytical flow path for injection in the second injection configuration I₂. More generally, the pump may be fluidly connected to a dead end, wherein said fluid connection comprises the injection path. In case a leak is detected when assuming the fourth leak test configuration, the first leak-test configuration and the second leak-test configuration may be used to localize a respective leakage (e.g., a defect sealing point) more precisely within the system.

Thus, with a single injection valve 10 the present invention allows for two different injection configurations, wherein a user may choose to either minimize the GDV by choosing the first injection configuration I₁, wherein the metering device 40 is not comprised by the analytical flow path during sample injection, or choose to set the GDV by opting for the second injection configuration I₂. The latter may advantageously allow a user to transfer method from an old HPLC system to the new HPLC system, since the GDV can be set to match the GDV of the older system. Alternatively, the GDV can be optimised by performing the injection without the metering device in the analytical path. In particular both options can be used with a single injection setup, i.e. without changing the hardware by replacing the injection valve or several valves involved in the injection. Again, the present invention can preferably be realized with a single distribution valve being directly involved in the injection, particularly a single distribution valve that enables establishing of the fluidic connections for injecting the sample. That is, switching from a sample-pickup configuration or a sample-precompression configuration to either one of the injection positions merely comprises changing the valve position of the single injection valve. It will be understood that this does not exclude other changes, e.g. movement of the sample pickup means.

Moreover, embodiments of the present invention may allow for sample precompression, flushing the pump (purge), repeated drawing of sample with large sample quantities (multidraw) and/or provide diagnostic functions such as leakage tests. Additionally, no further switching aids, such as active or passive valves, e.g. check valves, may be needed for injecting a sample.

It will be understood that it may be beneficial to avoid undesired connections and/or interruptions of fluidic paths when switching from one configuration to another. Otherwise, undesired pressure drops and/or fluid flows as well as carryover and/or critical pressure increases may occur. This may for example be of particular relevance when an undesired connection is made to a fluidic path that is at atmospheric pressure, e.g., if a connection to the waste is briefly established when switching from the pre-compression position to an injection position since the sample loop may drop back to atmospheric pressure.

For example, once the separation is equilibrated, a fluidic connection between solvent pump 20 and the separation column 30 is upheld at least until the sample is analysed. Otherwise, the pump 20 may pump against a dead end, which may cause an extremely rapid increase in pressure, typically triggering a safety shutdown. Furthermore, the pressure at the column may drop when disconnected form the pump, which would render re-equilibration necessary. Thus, the fluidic connection between solvent pump 20 and separation column 30 is upheld in the equilibration configuration, the sample-pickup configuration, the sample-precompression configuration and the two injection configurations. Even further, the different configurations are configured such that the system can switch between the equilibration configuration, the sample-pickup configuration, and the sample-precompression configuration without ever disconnecting the pump 20 from the separation column even during switching of the valve, i.e. relative movement of stator and rotor. It is noted that a very brief disconnection, as for example required for switching from the sample-precompression configuration to the first or second injection configuration, may be unavoidable and manageable due to fast switching times of the injection valve. Furthermore, switching from the sample-precompression configuration to the second injection may require switching “through” the first injection configuration, while not being ideal, it is also not problematic. The sample may be moved very briefly in the direction of the seat 64 but then the direction may be immediately reversed once assuming the second injection configuration.

Similarly, a connection to waste (without the separation column being part of said connecting) could possibly decompress an already pre-compressed sample loop before injection, which on the one hand may neutralize the benefit of precompression, but may also cause a rapid unloading of solvent into waste. This can lead to outgassing of the solvent, to abrasion, and can also be dangerous for s user if solvent splashes. The present invention also avoids undesired connections of pressurized flow paths to waste. For example, when switching from the sample-precompression configuration to either one of the injection configurations, the pressurized sample loop may not be fluidly connected to waste (without the separation column being part of said connection). Similarly, also the solvent pump may not be connected to waste in these configurations or when switching between those configurations. Thus, the respective sample-precompression configuration as well as the injection configurations are configured such that no pressurized flow path is fluidly connected to waste when assuming these configurations and when switching between these configurations.

Even more generally, the solvent pump is only fluidly connected to waste (without the separation column being part of said fluid connection) in the pump-purge configuration and the metering-device wash configuration. In which cases the pressure provided by the pump may be reduced prior to switching. Thus, configurations are configured such that no pressurized flow path is fluidly connected to waste without the separation column being part of said connection when assuming and/or switching between the equilibration, the sample-pickup configuration, the sample-precompression configuration, and either of the sample injection configurations.

Similarly, creating an incorrect connection during switching, where two connected flow paths have different pressures, can also lead to unwanted flow, i.e. sample loss and carryover. Therefore, the present invention generally allows also to avoid such undesired connection between flow paths of different pressures during switching.

With reference to FIGS. 12 and 13 the present invention also relates to a method for operating a chromatography system, wherein the chromatography system comprises a pump 20, a metering device 40, a sample loop 50, a separation column 30, and an injection valve 10. Generally, the chromatography system 1 may comprise features as described above with respect to FIGS. 1 to 11.

The method comprises the step 202 of injecting a sample stored in the sample loop 50 into the separation column, without the metering device 40 being part of an analytical path and the step 206 of injecting a sample stored in the sample loop 50 into the separation column 30 with the metering device 40 being part of the analytical path without any changes to the system hardware, wherein the analytical path generally denotes the flow path between the pump 20 and the separation column 30. It will be understood that steps 202 and 206 can be performed in an arbitrary order and may relate to completely different analysis runs on the same chromatography system.

The step 202 of injecting a sample stored in the sample loop 50 into the separation column 30, without the metering device 40 being part of the analytical path may comprise the system assuming the first injection configuration I₁ further explained above (cf. FIG. 1). Similarly, the step 206 of injecting a sample stored in the sample loop 50 into the separation column 30 with the metering device 40 being part of the analytical path may comprise assuming the second injection configuration I₂ further explained above (cf. FIG. 2).

Further, the step 202 of injecting a sample without the metering device being part of the analytical path may comprise decompressing the metering device, e.g. reducing the pressure within the metering device, preferably down to ambient pressure. Decompressing may be performed by moving the piston out of the housing. Furthermore, the step 202 may also comprise subsequently compressing the metering device to system pressure, i.e. pressurizing the metering device to system pressure by moving the piston into the housing. Such a controlled decompression and compression may advantageously allow to avoid pressure fluctuations when switching the valve position, e.g. after analysis, which may otherwise occur due to uncontrolled pressure loss in the metering device during long analysis due to leaks.

In particular, the above steps can be performed without any manual changes to the system hardware. More specifically, no parts (e.g. rotor or stator) or components (e.g. injection valve 10) need to be exchanged or replaced and no changes to the tubing of the system are required. This advantageously allows to freely switch between injection with and without the metering device 40 being present in the fluidic connection.

The method may further comprise a step 210 of equilibrating the separation column with solvent. Preferably during equilibrating the separation column the analytical path comprises only the pump 20 the injection valve 10 and the separation column, as well as the tubing. It will be understood that also sensors or the like can be part of the analytical path, but not any of the other system components specifically mentioned herein, namely the metering device 40, the sample loop 50, the sample pickup means 62, the seat 64, or the waste 70. The step of equilibrating the column may comprise assuming the equilibration configuration further explained above (cf. FIG. 3).

Additionally, the method may comprise a step 220 of picking up a sample and storing it in the sample loop 50. Preferably, the sample is picked up by moving the sample pickup means 62 to a respective sample vial and drawing in sample using the metering device 40 fluidly connected to the sample pickup means 62 via the sample loop 50. In particular, picking up a sample may comprise moving the piston 44 out of the housing 42 of the metering device to provide a negative pressure needed for drawing in the sample. Preferably, the pump 20 remains fluidly connected to the separation column, e.g. to keep the separation column 30 equilibrated. The step of picking up a sample and storing it in the sample loop 50 may comprise assuming the sample-pickup configuration further explained above (cf. FIG. 4).

The step of picking up a sample and storing it in the sample loop 50 may further comprise picking up a first portion of sample and storing it in the sample loop 50, draining solvent from the metering device 40 to waste and picking up a second portion of sample and storing it in the sample loop 50 together with the first portion. It will be understood that depending on a desired sample size, also further sample portions or portions of other liquids (e.g. solvents) may be picked up with intermitted draining of the metering device.

Draining solvent from the metering device 40 to waste 70 may comprise assuming a configuration wherein the metering device is fluidly connected to waste and to a dead end, e.g. the equilibration configuration. Assuming the equilibration configuration may be advantageous since it may allow to provide a continuous flow of solvent to the separation column. That is, the sample-pickup configuration may be assumed and a first portion of sample may be picked up (i.e. drawn in) and stored in the sample loop. Subsequently the equilibration configuration may be assumed and solvent may be drained from the metering device 40 to waste 70. Subsequently, the sample-pickup configuration may be assumed again and a second portion of sample may be picked up and stored in the sample loop 50 together with the first portion. This may also be referred to as multidraw since multiple portions of sample may be picked up and stored in the sample loop 50. It will be understood that generally also other portions of fluids, such as liquids and particularly solvents may be picked up during such a multi-draw procedure, e.g. for sample dilution.

The method may further comprise a step 230 of pre-compressing the sample. That is, the method may comprise bringing a sample stored in the sample loop 50 to system pressure. Preferably the sample is brought to system pressure by means of the metering device 40. That is, the metering device may pressurize the sample in the sample loop 50 by moving the piston 44 into the housing 42. The step of pre-compressing the sample may comprise assuming the sample-precompression configuration further explained above (cf. FIG. 5).

Subsequently the sample may be injected into the analytical path and thus provided to the separation column 30 for analysis as described above. In particular, the method may comprise a step 240 of detecting sample constituents in an effluent of the separation column with a respective detector, e.g. a CAD, a mass spectrometer, a fluorescence detector, a refractive-index detector, an absorbance detector, or an evaporative-light-scattering detector.

Furthermore, the method may comprise a step 250 of washing, refilling, and/or equilibrating the metering device, the seat, sample pickup means, sample loop the injection valve and/or separation column. This step may comprise assuming the second injection configuration, thereby allowing the pump to provide a solvent to the metering device, the seat, the sample pickup means, the sample loop and the separation column to wash said components, optionally refill the metering device and/or equilibrate the system. It will be understood that also the ports and connecting elements of the injection valve that are involved in injection namely the first, second third, fifth and sixth port and the first second and fourth connecting element. Furthermore, It will be understood that the separation column may also be (further) equilibrated after assuming the equilibration configuration.

Additionally, the method may comprise a step 260 of decompressing the sample loop, the seat, the sample pickup means and the metering device. Said step 260 may preferably be performed after injecting the sample and optionally performing step 250. The step 260 of decompressing may advantageously allow to bring the sample loop back to ambient pressure in preparation for a subsequent sample pick up.

With reference to FIG. 14, the method may also comprise a step 270 of purging the pump 20. That is, the pump may be purged by providing a solvent stream that directly goes to waste 70. This may allow to clean the pump and particularly purge any remaining solvents from a previous analysis run, e.g. when using a gradient with a changing solvent composition. The step of purging the pump may comprise assuming the pump-purge configuration.

Additionally or alternatively, the method may comprise a step 280 washing the metering device 40. The step of washing the metering device 40 may comprise rinsing the metering device 40 by providing a solvent flow through the metering device 40, which may subsequently be directed to waste 70. This may advantageously allow to remove any contaminants from the metering device, e.g. residues of previously used solvents. The step of washing the metering device 40 may comprise assuming the metering-device wash configuration further explained above.

The method may comprise a step 290 of performing system diagnostics wherein leaks within the system may be detected. Again, leak test may be performed by pressurizing certain fluidic paths of the system and either monitoring a decay of a once established pressure over time or monitoring a piston movement required to maintain a certain pressure. Both methods may allow to quantify a leakage. System diagnostics may for example be performed at the beginning of a measurement to perform an initial system check.

Performing system diagnostics may comprise performing a leak test for the sample pickup means 62 and the seat 64. In particular, the pump 20 may be used to pressurize the sample loop 50, sample pickup means 62 and seat 64 to detect any leak. The step of performing a leak test for the sample pickup means 62 and the seat 64 may comprise assuming the first leak-test configuration (cf. FIG. 8).

Performing system diagnostics may comprise performing a leak test for the metering device 40. In particular, the pump 20 may be used to pressurize the metering device 40 to detect any leak. The step of performing a leak test for the metering device 40 may comprise assuming the second leak-test configuration (cf. FIG. 9).

Performing system diagnostics may comprise performing a leak test for the pump 20. In particular, the port directly fluidly connected to the pump may be directly connected to a dead end to detect any leak in the pump or associated tubing. Thus, by running the pump to provide a solvent while being connected to a dead end, the pump and particularly the pump outlet and connected tubing are pressurized. The step of performing a leak test for the pump 20 may comprise assuming the third leak-test configuration (cf. FIG. 10).

Performing system diagnostics may comprise performing a leak test for the injection path comprising the metering device 40, the sample loop 50, the sample pickup means 62 and the seat 64. In particular, the injection path may be pressurized by the pump 20 to detect any leak in the injection path. The step of performing a leak test for the injection path may comprise assuming the fourth leak-test configuration (cf. FIG. 11).

It will be understood that during system diagnostics and particularly when performing any of the above-described leak tests, also the involved parts of the injection valve may be leak tested, e.g. the involved ports and connecting elements.

Again, it is noted that the disclosed steps may not necessarily be performed in the order depicted in FIGS. 13 and/or 14. For example, the metering device may be washed prior to purging the pump. Furthermore, some of the steps may be optional. For example, it may not be required to purge the pump after each injection and analysis. Furthermore, system diagnostics may not be required for every sample run.

It will be understood that the terms “first”, “second”, “third”, etc. merely serve to clearly distinguish between otherwise like components, e.g. ports of the injection valve. Within the scope of the invention these terms do not serve to indicate any hierarchy or order of the designated components. Thus, a system comprising a “third” component is not required to also comprises a respective “second” component.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. Method for operating a chromatography system, wherein the chromatography system comprises a pump, a metering device, a sample loop, a separation column, and an injection valve, the method comprising
injecting a sample stored in the sample loop into the separation column, without the metering device being part of an analytical path; and
injecting a sample stored in the sample loop into the separation column with the metering device being part of the analytical path;
wherein the analytical path denotes a flow path between the pump and the separation column.

2. The method according to claim 1,
wherein the step of injecting a sample without the metering device being part of the analytical path comprises the system assuming a first injection configuration, wherein the analytical path comprises the sample loop, the sample pickup means, and the seat, but not the metering device; and
wherein the step of injecting a sample with the metering device being part of the analytical path comprises the system assuming a second injection configuration, wherein the analytical path comprises the metering device, the sample loop, the sample pickup means and the seat.

3. The method according to claim 1, wherein the step of injecting a sample with the metering device being part of the analytical path comprises adjusting the gradient delay volume in the analytical path by means of the metering device.

4. The method according to claim 1, wherein the hardware of the system including comprised parts, components and the respective tubing are not manually changed during the method.

5. The method according to claim 1, wherein the method comprises performing system diagnostics to detect leaks within the system.

6. A chromatography system comprising
an injection valve comprising at least 6 ports,
a pump,
a separation column,
a metering device,
a sample loop,
a sample pickup means, and
a seat configured to receive and fluidly connect to the sample pick up means;
wherein the system is configured to assume a first injection configuration, wherein an outlet of the pump is fluidly connected to an inlet of the separation column and wherein a resulting flow path between the pump and the separation column comprises the sample loop, the sample pickup means, and the seat, but not the metering device; and
wherein the system is configured to assume a second injection configuration, wherein the outlet of the pump is fluidly connected to the inlet of the separation column and wherein a resulting flow path between the pump and the separation column comprises the metering device, the sample loop, the sample pickup means and the seat.

7. The chromatography system according to claim 6,
wherein the injection valve comprises a rotor and a stator;
wherein the injection valve comprises at least four connecting elements; and
wherein all connecting elements are comprised by the rotor.

8. The chromatography system according to claim 6, wherein the system comprises only a single injection valve directly involved in the sample injection.

9. The chromatography system according to claim 6, wherein in the first injection configuration I₁ the resulting flow path between the pump and the separation column does not comprise dead volume within the injection valve.

10. The chromatography system according to claim 6, wherein in the second injection configuration I₂ the resulting flow path between the pump and the separation column does not comprise dead volume within the injection valve downstream of the sample loop.

11. The chromatography system according to claim 6, wherein the system is further configured to assume a sample-precompression configuration designed to pressurize a sample in the sample loop to system pressure.

12. The chromatography system according to claim 6,
wherein the system comprises a controller configured to control the system during operation; and
wherein the controller is configured to perform the method of:
injecting a sample stored in the sample loop into the separation column, without the metering device being part of an analytical path; and
injecting a sample stored in the sample loop into the separation column with the metering device being part of the analytical path;
wherein the analytical path denotes a flow path between the pump and the separation column.

13. Computer program product comprising instructions which, when the program is executed by a chromatography system according to claim 6, cause the chromatography system to carry out the method of:
injecting a sample stored in the sample loop into the separation column, without the metering device being part of an analytical path; and
injecting a sample stored in the sample loop into the separation column with the metering device being part of the analytical path;
wherein the analytical path denotes a flow path between the pump and the separation column.
